(19) United States
(12) Patent Application Publication
(10) Pub. No.: US 2021/0069805 A1
(43) Pub. Date: Mar. 11, 2021

(54) PIPE CUTTER

(71) Applicant: TECHTRONIC CORDLESS GP, Anderson, SC (US)

(72) Inventors: Brent N. Gregorich, Easley, SC (US); Zachary P. Scott, Pendleton, SC (US); Carl N. Chandler, Greenville, SC (US)

(21) Appl. No.: 16/566,153

(22) Filed: Sep. 10, 2019

(51) Int. Cl. B23D 21/04; B23D 21/10

(52) U.S. Cl. CPC B23D 21/04; B23D 21/10

(57) ABSTRACT

A cutting tool includes a housing, a motor positioned within the housing, a pipe holder formed in the housing, a blade pivotally coupled respective to the pipe holder at a pivot point for movement relative to the pipe holder during a cutting motion, a drive mechanism including a first gear, and a quick-change mechanism rotationally coupling the blade to the first gear. The quick-change mechanism is operable to selectively de-couple the blade from the first gear to remove the blade for replacement.

### FIELD

The present subject matter generally relates to power tools and, more specifically, to battery-powered pipe cutters.

### BACKGROUND

Manually operated pipe cutters perform cutting operations in various ways, such as by a sawing motion or by successive ratcheting of a pipe cutter knife through a pipe. Oftentimes, these methods of pipe cutting result in imperfect cuts or, when cutting a pipe of a material such as PVC, snapping of the pipe. Manually operated pipe cutters can also cause ergonomic difficulties for the user. In particular, a user having relatively small hand size or low hand or wrist strength may experience difficulty completing a pipe cut. Additionally, the use of manually-operated pipe cutters can be time consuming.

### SUMMARY

In one aspect, the subject matter set forth herein provides a cutting tool including a housing, a motor positioned within the housing, a pipe holder formed in the housing, a blade pivotally coupled respective to the pipe holder at a pivot point for movement relative to the pipe holder during a cutting motion, a drive mechanism including a first gear, and a quick-change mechanism rotationally coupling the blade to the first gear, the quick-change mechanism being operable to selectively de-couple the blade from the first gear to remove the blade for replacement.

In another aspect, the subject matter herein provides a cutting tool including a housing, a motor positioned within the housing, a pipe holder formed in the housing, a blade pivotally coupled respective to the pipe holder at a pivot point for movement relative to the pipe holder during a cutting motion, a drive mechanism including a first gear, a latch axially movable relative to the housing for selectively rotationally coupling the blade to the first gear, thereby transferring torque from the drive mechanism to the blade causing it to pivot about the pivot point, a spring configured to bias the latch toward a first position, and a spindle configured to support the first gear for rotation relative to the housing, wherein the latch is coaxial with the spindle and a pivot axis of the first gear, wherein in the first position, the latch is configured to maintain the blade a locked configuration relative to the housing, and wherein in a second position, the latch is configured to release the blade.

Other aspects of the present subject matter will become apparent by consideration of the detailed description and accompanying drawings.

### BRIEF DESCRIPTION OF THE DRAWINGS

FIG. 1 is a perspective view of a pipe cutter according to an embodiment of the present disclosure.

FIG. 2 is a cross-sectional view of the pipe cutter of FIG. 1 taken along line 2-2 in FIG. 1.

FIG. 3 is an exploded view of a drivetrain of the pipe cutter of FIG. 1.

FIG. 4A is a side perspective view of the pipe cutter of FIG. 1 with a portion of the housing removed, illustrating a blade of the pipe cutter in a first, open position.

FIG. 4B is a side perspective view of the pipe cutter of FIG. 1 with a portion of the housing removed, illustrating the blade in a second, closed position.

FIG. 5A is a side perspective view of the pipe cutter of FIG. 1 with a portion of the housing removed, illustrating the blade in a fully secured position relative to the housing.

FIG. 5B is a side perspective view of the pipe cutter of FIG. 1 with a portion of the housing removed, illustrating the blade in a partially removed position relative to the housing.

FIG. 5C is a side perspective view of the pipe cutter of FIG. 1 with a portion of the housing removed, illustrating the blade in a fully removed position relative to the housing.

Before any embodiments of the present subject matter are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways. Also, it is to be understood that the phraseology and terminology used herein is for the purpose of description and should not be regarded as limiting.

### DETAILED DESCRIPTION

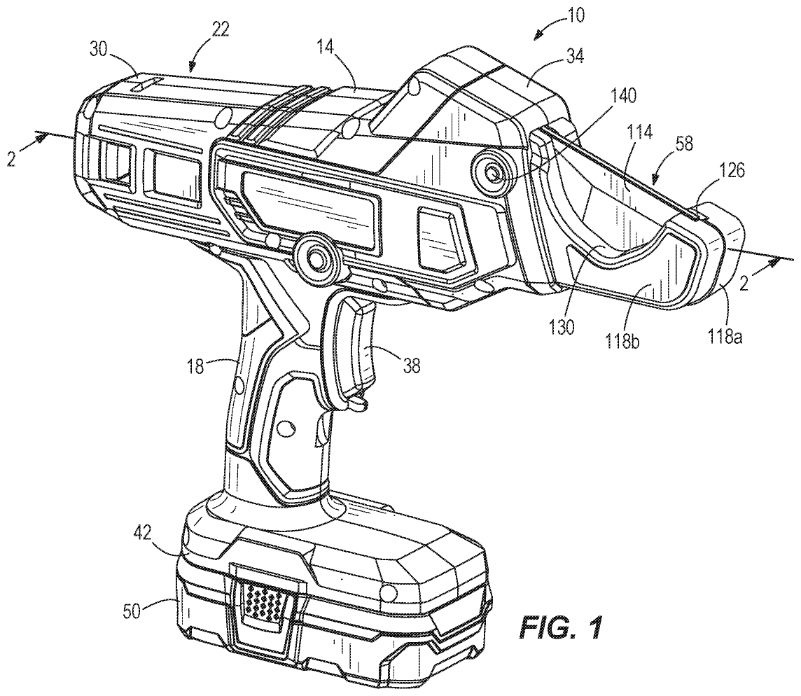

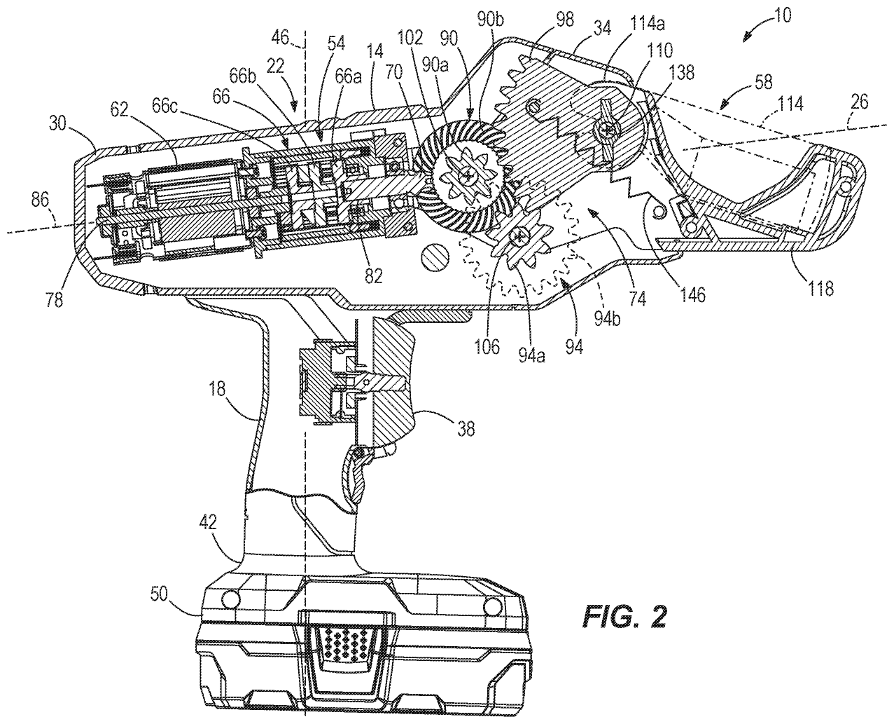

FIGS. 1 and 2 illustrate a power tool 10 according to an embodiment of the present disclosure. In the illustrated embodiment, the power tool 10 is a pipe cutter operable to cut a variety of pipes. For example, the illustrated pipe cutter 10 is adapted to cut a cross-linked polyethylene (PEX) pipe.

The pipe cutter 10 includes a pistol-grip style housing 14 having a handle portion 18 configured to be gripped by a user during operation of the pipe cutter 10, and a drive unit support portion 22. The housing 14 also defines a longitudinal axis 26 extending through a rearward portion 30 and a front portion 34 of the housing 14. The handle portion 18 supports a trigger 38 for operating the pipe cutter 10 and a battery support portion 42. The handle portion 18 extends along an axis 46 generally transverse to the longitudinal axis 26. With reference to FIGS. 1 and 2, the battery support portion 42 supports a battery 50, which may include a lithium-ion power tool battery pack, for providing electrical power to the pipe cutter 10 and/or components thereof. Referring to FIG. 2, the drive unit support portion 22 supports a drive unit 54, and a cutting mechanism 58 is supported within a front portion 34 of the housing 14. As described in more detail below, the drive unit 54 is operatively coupled to the cutting mechanism 58 to perform a cutting operation on a workpiece (e.g., a pipe (e.g., a PEX pipe), and/or the like).

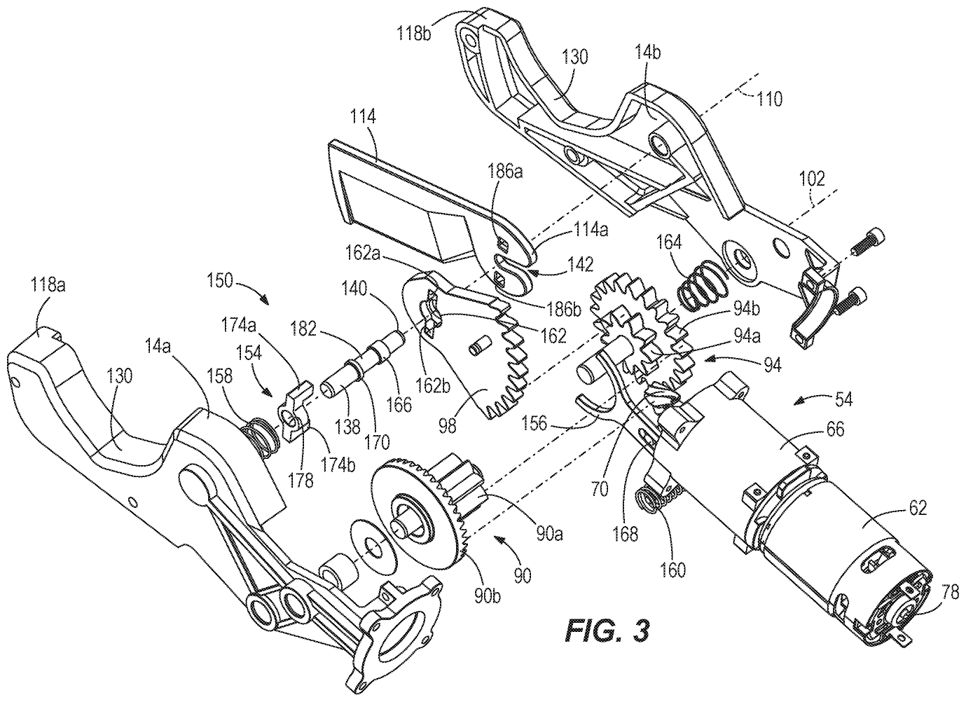

Referring to FIG. 2, the drive unit 54 includes a motor 62, a transmission 66, a transmission output shaft 70, and a drive mechanism 74. In the illustrated embodiment of the cutting tool 10, the motor 62 is a brushed DC electric motor capable of producing a rotational output through a motor output shaft 78 which, in turn, provides a rotational input to the transmission 66. Use of a brushless motor is also contemplated. In the illustrated embodiment, the transmission 66 is configured as a planetary transmission 66 having multiple planetary stages (e.g. two planetary stages, three planetary stages, and/or the like). As FIG. 2 illustrates three planetary stages 66a, 66b, 66c may be provided, although any number of planetary stages may be alternatively used. The transmission output shaft 70 is coupled for co-rotation with a carrier 82 in the third planetary stage 66a of the transmission 66 to thereby receive the torque output of the transmission 66. As shown in FIGS. 2-3, the transmission output shaft 70 includes an output gear or pinion at a distal end thereof. Referring back to FIG. 2, the motor output shaft 78 defines a rotational axis 86 of the motor 62, transmission 66, and the transmission output shaft 70. In the illustrated embodiment, the rotational axis 86 is generally aligned or coaxial with the longitudinal axis 26 of the housing 14.

As shown in FIG. 2, the drive mechanism 74 is positioned at least partially within the front portion 34 of the housing 14 between the motor 62 and the cutting mechanism 58. The illustrated drive mechanism 74 includes a first, driven gear 90, a second, intermediate gear 94, and a third, output gear 98. Specifically, the driven gear 90 includes an inner gear 90a and an outer gear 90b (FIG. 2) coupled together for co-rotation around a driven gear axis 102 (FIG. 3), and the intermediate gear 94 includes an inner gear 94a and an outer gear 94b coupled together for co-rotation around an intermediate gear axis 106. The transmission output shaft 70 meshes with the outer driven gear 90b to cause rotation of the driven gear 90 about the driven gear axis 102. The inner driven gear 90a meshes with the outer intermediate gear 94b to cause rotation of the intermediate gear 94 about the intermediate gear axis 106. Furthermore, the output gear 98 meshes with the inner intermediate gear 94a to cause rotation of the output gear 98 about an output gear axis 110. The output gear 98 is additionally coupled to the cutting mechanism 58, such that rotation of the output gear 98 causes movement of (e.g., drives) the cutting mechanism 58.

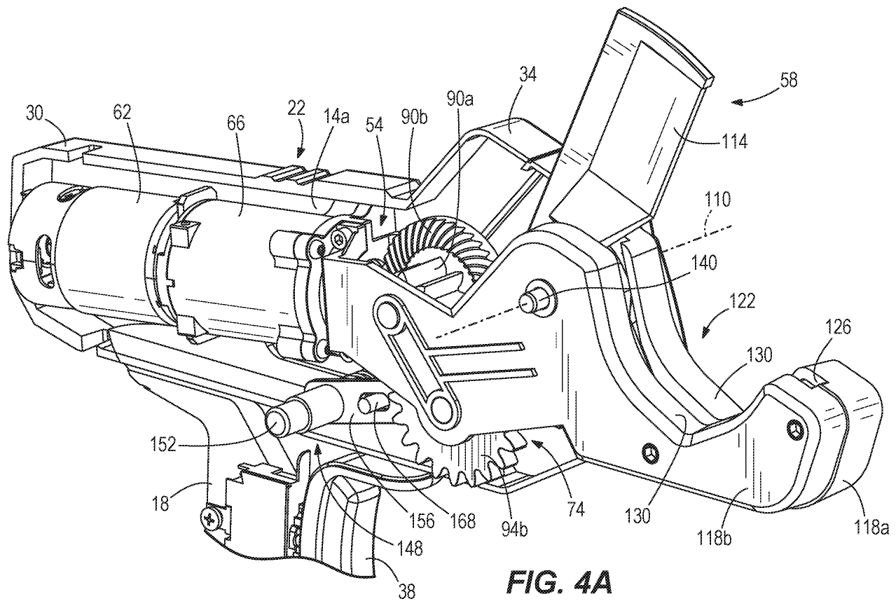

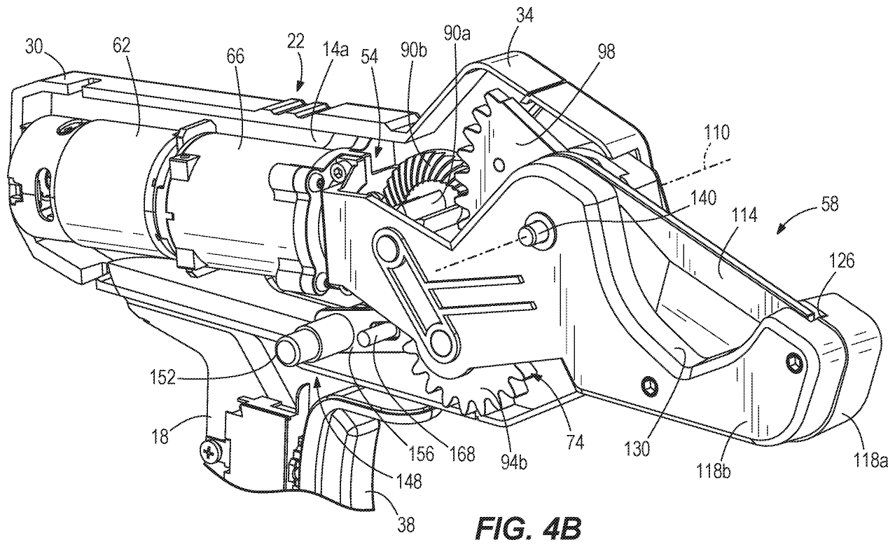

With reference to FIGS. 3-4B, the cutting mechanism 58 is coupled to the front portion 34 of the housing 14 and includes a movable blade 114 and a stationary pipe guide, or pipe holder 118. The cutting mechanism 58 is driven by the drive mechanism 74 and operates to control cutting motion of the blade 114, which performs the cutting action of the pipe cutter 10. The blade 114 is pivotally movable relative to the housing 14 and the pipe holder 118. Together, the blade 114 and the pipe holder 118 define a space 122 for receiving a pipe to be cut (FIG. 4A). The pipe holder 118, which is stationary relative to the housing 14, is formed of two clamshell halves 118a, 118b, and forms a slot 126 therebetween for receiving the blade 114 during a cutting operation. The pipe holder 118 includes a convex surface 130 facing the blade 114 for providing support for a pipe during the cutting action and helps to align the pipe to be cut. The pipe holder 118 may be integrally formed with the housing 14 or may be separately coupled to the forward portion 34 of the housing 14. The pipe holder 118 may be formed from a hard plastic material, a metal material, and/or any other material or combination of materials suitable for supporting a pipe during the cutting activity.

A first end 114a of the blade 114 is rotatably coupled to the output gear 98 at a pivot point along the output gear axis 110 (FIG. 3). More specifically, the first end 114a of the blade 114 includes a U-shaped slot 142 configured to engage a spindle 138, which is coaxial with the axis 110, upon which the output gear 98 is rotatably supported. The blade 114 may be biased upwards, away from the pipe holder 118, to a first position (FIG. 4A) for receiving a pipe within the space 122. A spring 146 (FIG. 2) extends between the output gear 98 and the pipe holder 118 to bias the blade 114 to the first position. In the illustrated embodiment, the spring 146 is an extension spring attached to the output gear 98 at one end and an internal portion of the pipe holder 118 at an opposite end. As the output gear 98 rotates, the blade 114 pivots about the output gear axis 110 toward the pipe holder 118, causing the spring 146 to extend and store energy.

With reference to FIGS. 4A-4B, the drive mechanism additionally includes a blade return mechanism operable by the user to retract the blade 114 from a second position (FIG. 4B) to the first position after a cutting operation. The blade return mechanism includes a blade retract actuator 148 including a cap 152 and a lever 156. The actuator 148 engages a first end of the lever 156. A first spring 160 (FIG. 3) additionally engages the first end of the lever 156 and is biased in the direction of the actuator 148, opposite the bias of a second spring 164 (FIG. 3), which acts on the intermediate gear 94. A pin 168 extends through a slot in the lever 156.

During operation of the pipe cutter 10, a user positions a pipe in the space 122 such that the pipe rests on the concave surface 130 of the pipe holder 118. A user actuates the trigger 38 to activate the motor 62 and, thereby, drive the drive unit 54. The output shaft 70 intermeshes with and drives the driven gear 90 of the drive mechanism 74, which rotates the intermediate gear 94. As the intermediate gear 94 rotates, the output gear 98 also rotates to pivot the blade 114. As the intermediate gear 94 rotates, the blade 114 pivots toward the pipe holder 118 such that the blade 114 cuts through a pipe positioned in the space 122 and protrudes into the slot 126, positioning the blade 114 in the second position. Once the blade 114 extends into the slot 126 of the pipe holder 118, the blade 114 will have completed the pipe cut and cutting motion and the spring 146 is tensioned to an unbiased position (FIG. 2B). The user may then depress the actuator 148 to return the blade 114 to the first position. When the actuator 148 is depressed, the force on the actuator 148 overcomes the bias of the first spring 160 on the first end of the lever 156, thereby causing a second end of the lever 156 to pivot about the pin 168 toward the intermediate gear 94. This movement overcomes the bias of the second spring 164 and moves the inner intermediate gear 94a out of engagement with the output gear 98. Once the inner intermediate gear 94a disengages the output gear 98, the spring 146 returns the blade 114 to the first position. When the actuator 148 is released, the bias of the springs 160, 164 moves the inner intermediate gear 94a back into engagement with the output gear 98, readying the pipe cutter 10 for another cutting operation.

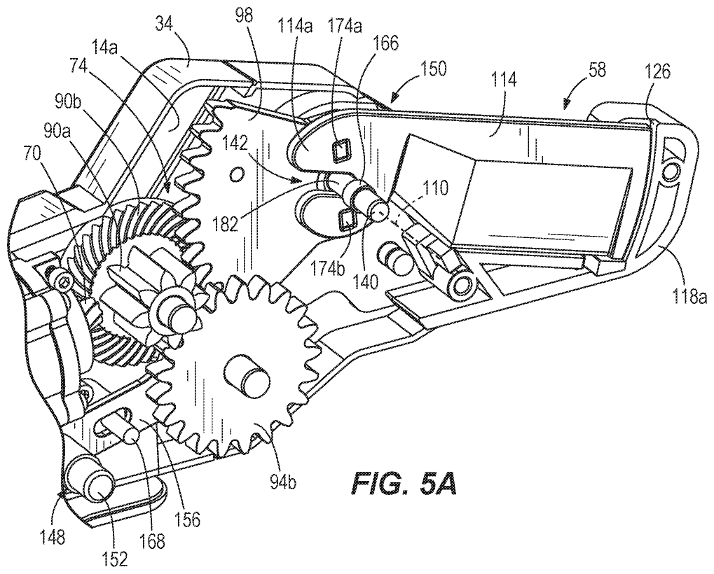

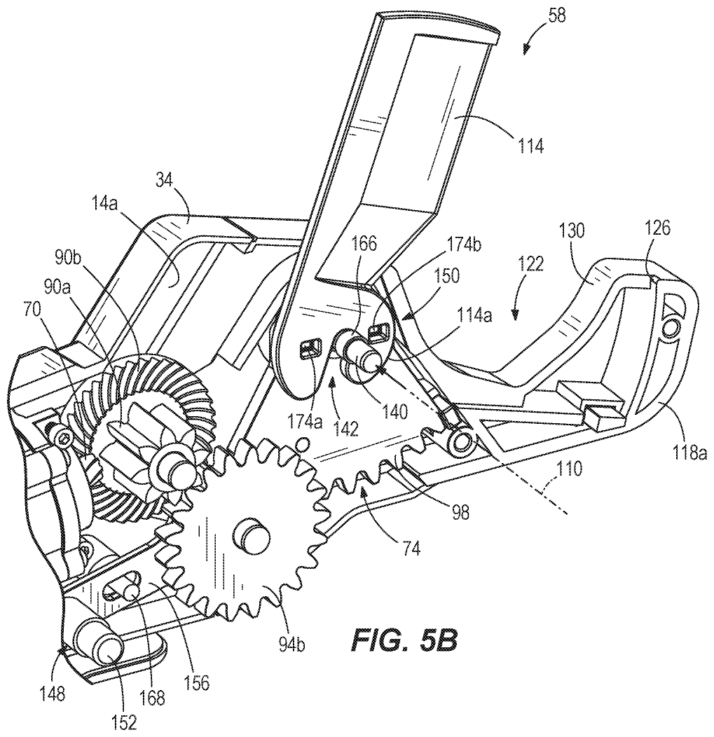

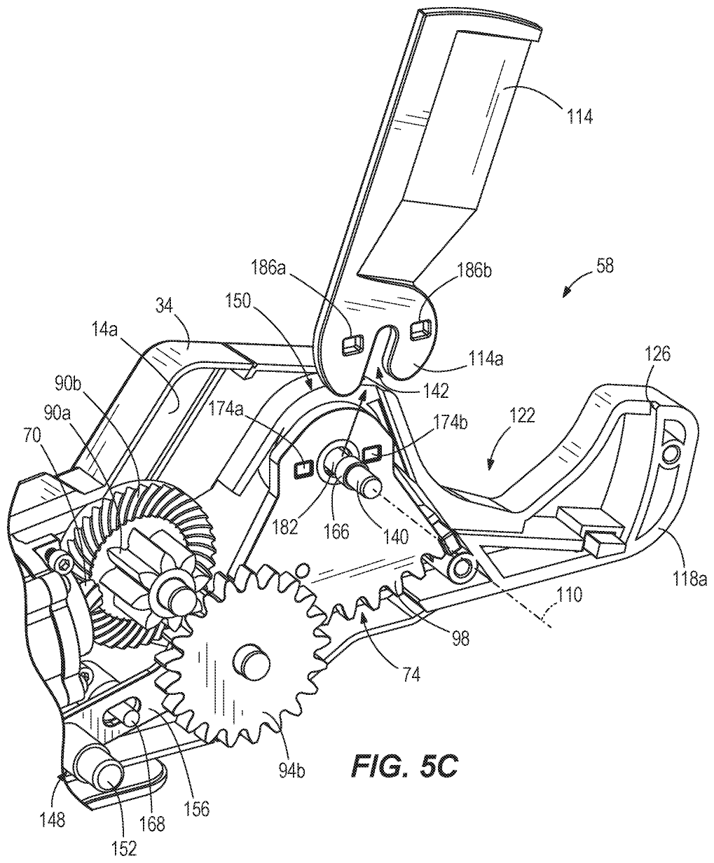

With reference to FIGS. 5A-5C, a user may remove the blade 114 from the tool 10 in the event of damage or necessary replacement via a quick-change, or blade removal, mechanism 150. The blade removal mechanism 150 includes the spindle 138 (FIG. 3), a support member or latch 154, and a biasing member 158. The spindle 138 is substantially cylindrical and positioned within the housing 14 along the output gear axis 110. The spindle 138 extends from a first inner wall 14a of the housing 14, and through a second inner wall 14b of the housing 14 substantially opposite the first inner wall 14a. Therefore, a portion 140 of the spindle 138 protrudes from the housing 14. More specifically, the protruding portion 140 is depressible by a user to actuate the blade removal mechanism 150. The spindle 138 extends through an aperture 162 of the output gear 98, such that the spindle 138 supports the gear 98 for rotation relative to the housing 14. The spindle 138 further includes a first shoulder 166, a second shoulder 170 spaced from the first shoulder 166, and a cylindrical pivot portion 182 positioned therebetween. The first and second shoulders 166, 170 protrude from the spindle 138, such that the first end 114a of the blade 114 is coupled to and pivotable about the cylindrical pivot portion 182 of the spindle 138.

The latch 154 is positioned along the output gear axis 110 between the first inner wall 14a of the housing 14 and the output gear 98 and is coaxial with the output gear axis 110 and the spindle 138. With continued reference to FIG. 3, the latch 154 includes a first key 174a, a second key 174b, and an aperture 178 extending through the latch 154 (FIG. 3). The first and second keys 174a, 174b are spaced apart from one another, such that the keys 174a, 174b are parallel to each other and parallel to the axis 110. The first and second keys 174a, 174b are configured to protrude through corresponding, adjoining keyways 162a, 162b in the aperture 162 of the output gear 98, and through corresponding keyways 186a, 186b of the blade 114. The aperture 178 is sized to receive the spindle 138, such that the latch 154 is slidable along the spindle 138.

The biasing member, or spring, 158 is positioned along the output gear axis 110 between the first inner wall 14a of the housing 14 and the latch 154. The biasing member 158 is configured to biase the latch 154 towards a first position coinciding with a locked configuration of the blade 114 (FIG. 5A). Additionally, the latch 154 is axially movable along the output gear axis 110, against the bias of the biasing member 158, toward a second position coinciding with an unlocked configuration of the blade 114 (FIG. 5C). In the locked configuration, the blade 114 is coupled to the output gear 98 via the latch 154 for co-rotation therewith, such that the latch 154 connects the blade 114 to the drive mechanism 74 for a cutting operation. More specifically, when the blade 114 is in the locked configuration, the biasing member 158 is configured to biase the latch 154 against the output gear 98, thereby abutting the second sleeve 170 of the spindle 138 against the output gear 98. The latch 154 extends through the output gear aperture 162, thereby causing engagement of the keys 174a, 174b with the keyways 162a, 162b. The keys 174a, 174b of the latch 154 further extend through the blade keyways 186a, 186b, coupling the blade 114 to the output gear 98. Therefore, in this position, the latch 154, the output gear 98, and the blade 114 are coupled for co-rotation about the output gear axis 110. As such, when in the first position, the latch 154 maintains the blade 114 in the locked configuration and rotationally couples the blade 114 to the output gear 98. Specifically, the blade removal mechanism 150 rotationally unitizes the blade 114 and the output gear 98 such that torque can be transferred from the output gear 98 to the blade 114 (via the latch 154), causing the blade to pivot 114.

Alternatively, when the blade 114 is in the unlocked configuration (FIG. 5C), the spindle 138 is depressed and the biasing member 158 is compressed to an unbiased position away from the blade 114. More specifically, the first shoulder 166 of the spindle 138 abuts against the blade 114, biasing the biasing member 158 and pushing the latch 154 away from the blade 114 along the output gear axis 110. The keys 174a, 174b of the latch 154 simultaneously disengage the blade keyways 186a, 186b, but remain engaged with the output gear keyways 162a, 162b. As such, the latch 154 is uncoupled from the blade 114, but remains coupled to the output gear 98. As such, the blade 114 is no longer constrained in a radial direction relative to the output gear axis 110, permitting the blade 114 to be removed from the tool 10 as shown in FIG. 5C.

FIGS. 5A-5C illustrate the removal process of the blade 114 using the blade removal mechanism 150. FIG. 5A illustrates the blade 114 in the locked configuration (in which the blade 114 is fully secured to the latch 154) and in the closed position. In this position, the biasing member 158 biases the latch 154 against the output gear 98, abutting the second sleeve 170 against the gear 98. The keys 174a, 174b are engaged with the gear keyways 162a, 162b and the blade keyways 186a, 186b, thereby coupling the latch 154, the output gear 98, and the blade 114 for co-rotation and preventing removal of the blade 114. Additionally, the blade 114 extends into the slot 126 of the pipe holder 118, further ensuring the blade 114 is irremovable from the tool 10. As such, in order to remove the blade 114 from the tool, the blade 114 must be in the open position.

FIG. 5B illustrates the blade 114 is a position between the locked and unlocked configuration. During operation, the protruding portion 140 of the spindle 138 may be depressed along the output gear axis 110. When the spindle 138 is depressed, the first shoulder 166 of the spindle 138 abuts against the blade 114, compressing the biasing member 158 and pushing the latch 154 away from the blade 114. The keys 174a, 174b simultaneously disengage the blade keyways 186a, 186b, uncoupling the blade 114 from the output gear 98, while maintaining the keys 174a, 174b within the output gear keyways 162a, 162b. So long as the spindle 138 is maintained in a depressed position, the blade 114 is not constrained in a radial direction relative to the output gear axis 110, permitting quick, efficient removal of the blade 114 from the tool 10, as shown in FIG. 5C. Upon release of the spindle 138, the biasing member 158 biases the spindle 138 back towards the biased position, causing the second shoulder 170 to abut against the latch 154, and the protruding portion 140 of the spindle 138 to again protrude through the housing 14.

Alternatively, in order to secure the blade 114 to the tool 10, the spindle 138 may be depressed and the blade 114 may be positioned along the cylindrical pivot portion 182 of the spindle 138. Specifically, the user may position the blade 114 such that the blade keyways 186a, 186b are aligned with the keys 174a, 174b of the latch 154. While maintaining the position of the blade 114, the user may release the spindle 138. The biasing member 158 biases the latch 154 against the output gear 98, and the second sleeve 170 of the spindle 138 abuts against the output gear 98. The keys 174a, 174b of the latch 154 extend through the blade keyways 186a, 186b, coupling the latch 154, the output gear 98, and the blade 114 for co-rotation about the output gear axis 110.

Although the subject matter herein has been described in detail with reference to certain preferred embodiments, variations and modifications exist within the scope of one or more independent aspects of the subject matter as described. Various features and advantages are set forth in the following claims.

What is claimed is:

1. A cutting tool comprising:
a housing;
a motor positioned within the housing;
a pipe holder formed in the housing;
a blade pivotally coupled respective to the pipe holder at a pivot point for movement relative to the pipe holder during a cutting motion;
a drive mechanism including a first gear; and
a quick-change mechanism rotationally coupling the blade to the first gear, the quick-change mechanism being operable to selectively de-couple the blade from the first gear to remove the blade for replacement.

2. The cutting tool of claim 1, wherein the quick-change mechanism includes:
a latch axially movable relative to the housing; and
a spring biasing the latch toward the blade.

3. The cutting tool of claim 2, wherein the spring biases the latch toward a first position coinciding with a locked configuration of the blade, and wherein the latch is movable against the bias of the spring toward a second position coinciding with an unlocked configuration of the blade.

4. The cutting tool of claim 3, wherein in the locked configuration, the blade is coupled to the first gear for co-rotation therewith, and in the unlocked configuration, the blade is removable from the first gear.

5. The cutting tool of claim 3, wherein the latch is coaxial with a pivot axis of the first gear.

6. The cutting tool of claim 5, wherein the quick-change mechanism includes a spindle supporting the first gear for rotation relative to the housing, and wherein the latch is coaxial with the spindle.

7. The cutting tool of claim 6, wherein the latch includes a key parallel with the pivot axis, and wherein the blade includes a first keyway in which the key is received when the latch is in the first position.

8. The cutting tool of claim 7, wherein the first gear includes a second keyway in which the key is received when the latch is in either the first position or the second position.

9. The cutting tool of claim 8, wherein the key is a first key, and wherein the latch includes a second key that is parallel with the pivot axis.

10. The cutting tool of claim 9, wherein the blade includes a third keyway in which the second key is received when the latch is in the first position, and wherein the first gear includes a fourth keyway in which the second key is received when the latch is in either the first position or the second position.

11. The cutting tool of claim 10, wherein the first and second keys are simultaneously removed from the first and third keyways in the blade in response to the latch being moved to the second position.

12. The cutting tool of claim 6, wherein the spindle includes
a shoulder against which the latch is abutted when in the first position, and
a cylindrical pivot portion adjacent the shoulder about which the blade is pivotable.

13. The cutting tool of claim 12, wherein a portion of the spindle protrudes from the housing, and wherein the portion of the spindle is pressed to move the latch from the first position, coinciding with the locked configuration of the blade, toward the second position, coinciding with the unlocked configuration of the blade.

14. The cutting tool of claim 1, further comprising a battery pack electrically coupled to the motor to selectively power the motor.

15. The cutting tool of claim 14, wherein the housing includes a handle portion, and wherein the battery pack is removably coupled to the handle portion.

16. A cutting tool comprising:
a housing;
a motor positioned within the housing;
a pipe holder formed in the housing;
a blade pivotally coupled respective to the pipe holder at a pivot point for movement relative to the pipe holder during a cutting operation;
a drive mechanism including a first gear;
a latch axially movable relative to the housing for selectively rotationally coupling the blade to the first gear, thereby transferring torque from the drive mechanism to the blade causing it to pivot about the pivot point;
a spring configured to bias the latch toward a first position; and
a spindle configured to support the first gear for rotation relative to the housing,
wherein the latch is coaxial with the spindle and a pivot axis of the first gear, wherein in the first position, the latch is configured to maintain the blade a locked configuration relative to the housing, and wherein in a second position, the latch is configured to release the blade.

17. The cutting tool of claim 16, wherein the latch includes a key parallel with the pivot axis, and wherein the blade includes a first keyway in which the key is received when the latch is in the first position.

18. The cutting tool of claim 17, wherein the first gear includes a second keyway in which the key is received when the latch is in either the first position or the second position.

19. The cutting tool of claim 16, wherein the spindle includes
a shoulder against which the latch is abutted when in the first position, and
a cylindrical pivot portion adjacent the shoulder about which the blade is pivotable.

20. The cutting tool of claim 19, wherein a portion of the spindle protrudes from the housing, and wherein the portion of the spindle is pressed to move the latch from the first position, coinciding with the locked configuration of the blade, toward the second position, where the latch releases the blade.
